(19) United States
(12) Patent Application Publication
(10) Pub. No.: US 2013/0171897 A1
(43) Pub. Date: Jul. 4, 2013

(54) PAD WITH FABRIC MATERIAL AND METHOD OF MANUFACTURING THE SAME

(71) Applicant: SU-TUAN HSU TANG, Tao Yuan Hsien (TW)

(72) Inventor: SU-TUAN HSU TANG, Tao Yuan Hsien (TW)

(21) Appl. No.: 13/342,213

(22) Filed: Jan. 3, 2012

(51) Int. Cl. B32B 5/22

(52) U.S. Cl. 442/76

(57) ABSTRACT

A method of manufacturing a pad with a fabric material includes: a step of providing the fabric material; a tension averaging step of averaging tension of the fabric material by way of stretching; a front-stage pressing step of increasing the density of the fabric material by way of pressing; a water removing step of removing water from the fabric material by way of thermal illumination; a coating step of applying a layer of a colloid paste onto the fabric material; a foaming step of foaming the colloid paste by way of thermal baking; a cooling step of cooling the colloid paste, obtained after the foaming step, and cooling the fabric material to form a layer of a glue pad on the fabric material; and a post-stage pressing step of pressing the glue pad and the fabric material to perform thickness correction and form a semi-facture of the pad.

### BACKGROUND OF THE INVENTION

(1) Field of the Invention

The invention relates to a pad and a method of manufacturing the same, and more particularly to a pad with a fabric material and a method of manufacturing the pad.

(2) Description of the Prior Art

Pads, such as a Yoga pad required for the Yoga exercise, an exercise pad for Pilates, a game pad required for playing a global fashionable somatosensory game (television game host XBOX360 plus a Kinect machine with the functions of sensing the human body and the main joints of the extremities) at the end of 2010 and the like, are soft pads manufactured by foaming a plastic fabric material.

Although the plastic and soft pads advantageously have the good elasticity, they have the drawbacks of the incapability of absorbing the sweat. When the sweat drops on the pad, the pad tends to be slippery to cause the danger of slip and cause the dirty to be formed, so that the pad cannot be easily cleaned.

In order to solve the above-mentioned drawbacks of the prior arts, some users only have to passively lay the towels on the pads. However, the towel is only laid on the pad and is not fixed to the pad. During the exercise, the laid towel tends to be messed, so that the drawback that the towel often has to be laid again is caused, or the user tends to fall down and encounters danger during the exercise due to the sliding of the towel.

### SUMMARY OF THE INVENTION

A primary object of the invention is to provide a pad with a fabric material and a method of manufacturing the pad, wherein one surface of a glue pad has the fabric material so that the pad can absorb the sweat through the fabric material, the dangerous conditions of slipperiness, slipping and falling down cannot be caused, and the pad can be directly put into a washer and washed. Also, the fabric material cannot be messed or crumpled during the exercise, and the pad can be easily cleaned after perspire in the exercise so that the bacteria growth and infection cannot be caused.

A secondary object of the invention is to provide a pad with a fabric material and a method of manufacturing the pad, wherein the fabric material is configured to have many openings so that a plastic paste can enter the openings during the manufacturing processes, and the fabric material appears the pattern formed by arranging the openings, so that the pad is patterned.

The invention achieves the above-identified objects by providing a method of manufacturing a pad. The method includes: a fabric material providing step of providing a fabric material, a tension averaging step, a front-stage pressing step, a water removing step, a coating step, a foaming step, a cooling step and a post-stage pressing step. In the tension averaging step, tension of the fabric material is averaged by way of stretching. In the front-stage pressing step, a density of the fabric material is increased by way of pressing. In the water removing step, water is removed from the fabric material by way of thermal illumination. In the coating step, a layer of a colloid paste is applied onto the fabric material. In the foaming step, the colloid paste is foamed by way of thermal baking. In the cooling step, the colloid paste, obtained after the foaming step by way of the thermal baking, and the fabric material are cooled, so that a layer of a glue pad is formed on the fabric material. In the post-stage pressing step, the glue pad and the fabric material are pressed to perform thickness correction so that a semi-facture of the pad is formed.

Thus, the pad can absorb the sweat, the dangerous conditions of slipperiness, slipping and falling down cannot be caused, and the pad can be directly put into a washer and washed. Also, the fabric material cannot be messed or crumpled during the exercise, and the pad can be easily cleaned after perspire in the exercise so that the bacteria growth and infection cannot be caused.

The invention further provides a pad including a fabric material and a glue pad. The fabric material has a fabric material organization, which includes a plurality of weaving gaps. The glue pad is combined with one surface of the fabric material by way of foaming, wherein the glue pad is combined with the fabric material deeply inside the weaving gaps of the fabric material and is thus completely combined with the fabric material organization.

Therefore, the pad can absorb the sweat, the dangerous conditions of slipperiness, slipping and falling down cannot be caused, and the pad can be directly put into a washer and washed. Also, the fabric material cannot be messed or crumpled during the exercise, and the pad can be easily cleaned after perspire in the exercise so that the bacteria growth and infection cannot be caused.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 shows the arrangement of the process flow of the manufacturing method of the invention.

FIG. 2 is a cross-sectional view showing a pad manufactured by the manufacturing method of the invention.

FIG. 3 is a flow chart showing the manufacturing method of the invention.

FIG. 4 is a pictorial view showing a method of manufacturing a pad according to another embodiment of the invention.

FIG. 5 is a schematic illustration showing the absorption of FIG. 4 according to the invention.

### DETAILED DESCRIPTION OF THE PREFERRED EMBODIMENTS

The invention provides a pad with a fabric material and a method of manufacturing the pad, such as a Yoga pad, an exercise pad for Pilates or a game pad for playing the somatosensory game, which can absorb the sweat, is free from the dangerous conditions of slipperiness or slipping and falling down and can be directly placed into a washer and washed. Also, the fabric material of the pad cannot be messed or crumpled during the exercise, and the pad can be easily cleaned after perspire in the exercise so that the bacteria growth and infection cannot be caused.

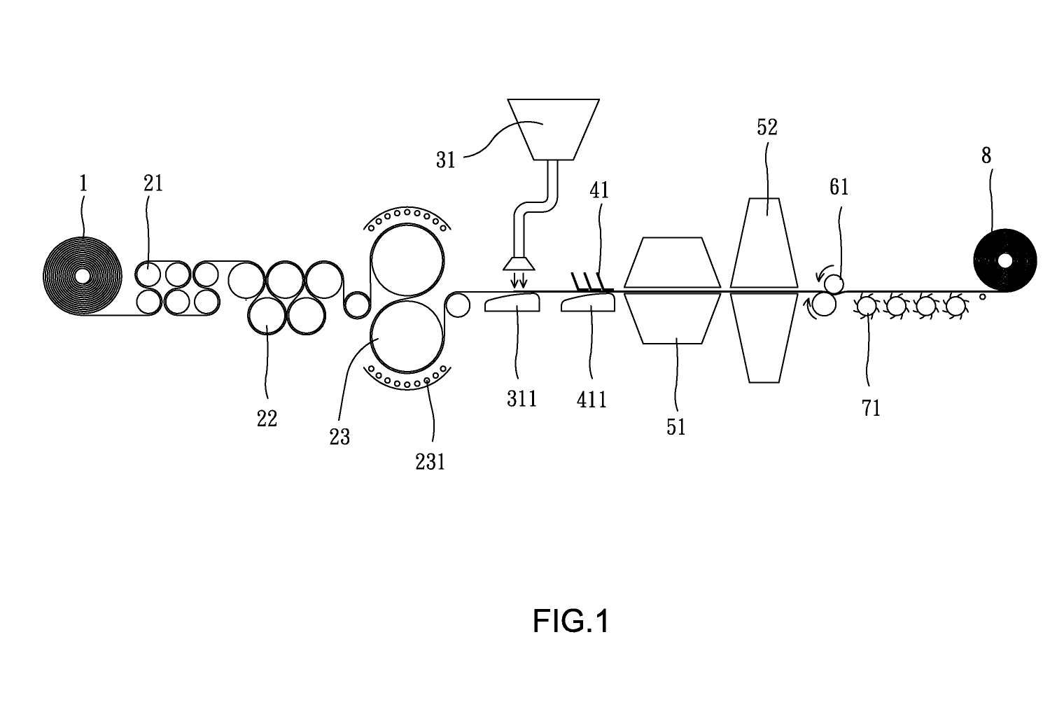

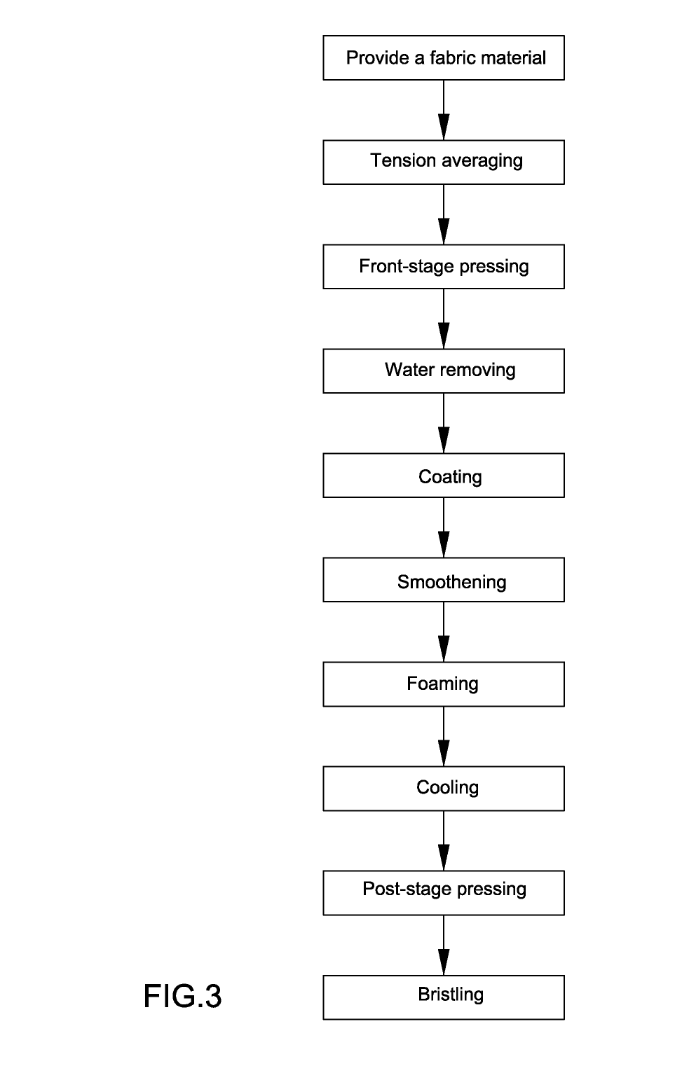

Referring to FIGS. 1 and 3, the manufacturing method of the invention includes a fabric material providing step, a tension averaging step, a front-stage pressing step, a water removing step, a coating step, a smoothening step, a foaming step, a cooling step, a post-stage pressing step and a bristling step.

In the fabric material providing step, a fabric material 1 is provided. The fabric material 1 may be an ultra-fine fiber cloth or towel cloth, and the ultra-fine fiber cloth may be composed of natural or artificial fibers such as cotton, polyester, Nylon and the like. In addition, the ultra-fine fiber cloth or towel cloth may be made by weaving a bamboo charcoal yarn to possess the deodorization effect, or may be made by weaving a polyethylene terephthalate (PETE) bottle recycled yarn to achieve the environment protective effect.

In the tension averaging step, the tension of the fabric material 1 is averaged by way of stretching. As shown in the drawing, the fabric material 1 wraps around and between a plurality of tension roller sets, each of which includes a plurality of tension rollers 21. Using the tension rollers 21 can adjust the fabric material 1 to the predetermined width, while the tension of the fabric material 1 is averaged by way of stretching.

In the front-stage pressing step, the density of the fabric material 1 is increased by way of pressing. As shown in the drawing, the fabric material 1 wraps around and between a plurality of front-stage pressure rollers 22 so that the fabric material 1 can be compacted and densified (the weaving gap of the fabric material 1 is reduced), the density of the fabric material 1 is increased, the penetration of the colloid paste can be avoided, the amount of the colloid paste absorbed by the fabric material 1 can be decreased, and the object of saving the colloid paste can be achieved.

In the water removing step, the water is removed from the fabric material 1 by way of thermal illumination (thermal energy illumination). As shown in the drawing, the fabric material 1 wraps around and between at least two heating rollers 23, wherein an electric heating lamp set is disposed on each of opposite sides of the two heating rollers 23, and each of the electric heating lamp sets includes a plurality of electric heating lamps 231. The thermal illumination of the electric heating lamps 231 on the fabric material 1 is utilized to remove the water from the fabric material 1. Thus, it is possible to prevent the fabric material 1 containing water from affecting the surface state after the coating step and to prevent the bubbles from being produced.

In the coating step, a layer of a colloid paste, which may be selected from PVC, PER, TPU, TPE, TPR and the like, is applied onto the fabric material 1. As shown in the drawing, a material bucket 31 is utilized to spray the colloid paste, accommodated within the bucket, onto the fabric material 1. A supporting element 311 is disposed below the fabric material 1 and opposite the material bucket 31 to support the coated fabric material 1, whose weight is increased due to the coating step. In addition, the supporting element 31 can also average the coating formed in the coating step. The material bucket 31 may be implemented by an inverter duty motor for controlling the feeding amount.

In the smoothening step, the colloid paste applied in the coating step is smoothened. As shown in the drawing, a plurality of scrapers 41 is disposed above the fabric material 1 applied with the colloid paste. The scrapers 41 smoothen the colloid paste on the translating (from left to right) fabric material 1. A supporting element 411 is disposed below the fabric material 1 and corresponding to the scrapers 41 to support the fabric material 1. Of course, the smoothening step may also be performed by scrapers (not shown) with scratches so that the surface of the colloid paste can be smoothened and scratched to form textures to enhance the anti-slip effect.

Each of the supporting elements 311 and 411 may be in the form of a substrate, or a plurality of small rollers arranged in parallel (not shown).

In the foaming step, the colloid paste is foamed by way of thermal baking. As shown in the drawing, the fabric material 1 applied with the colloid paste passes through two opposite ovens 51, so that a soft pad closely combined with the fabric material 1 is formed after the colloid paste attached to the fabric material 1 is foamed and shaped.

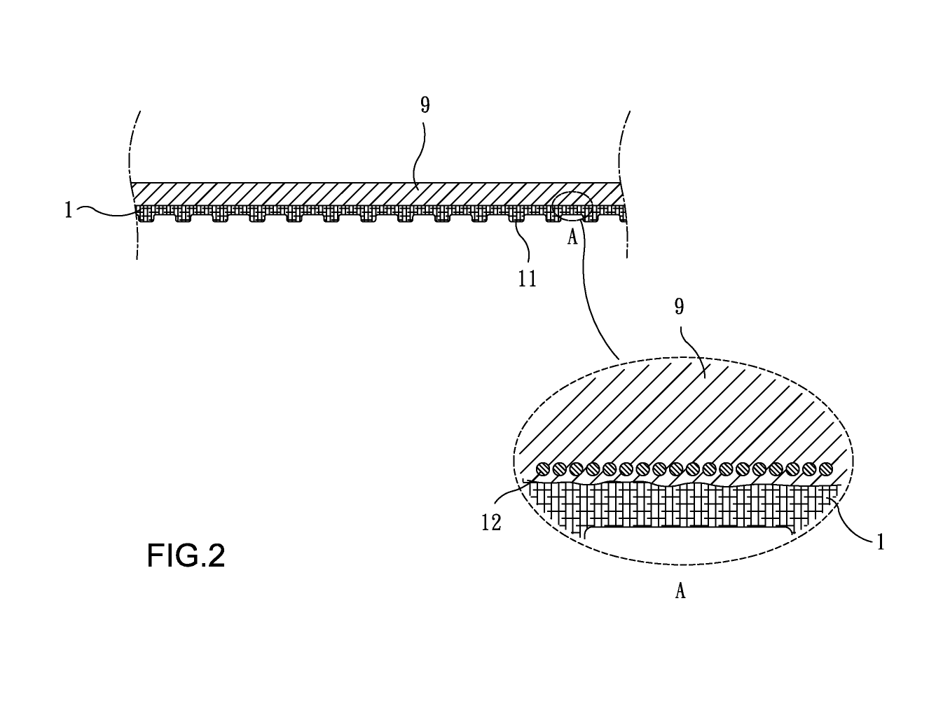

In the cooling step, the colloid paste, formed after the thermal baking and foaming step, together with the fabric material 1 are cooled so that a layer of a glue pad 9 (see FIG. 2) is formed on the fabric material 1. As shown in FIGS. 1 and 3, the fabric material 1 with the foamed colloid paste passes through two opposite cooling devices 52, so that a layer of the elastic glue pad 9 is formed on the fabric material 1.

In the post-stage pressing step, the glue pad 9 together with the fabric material 1 are pressed so that the thickness correction of the pad is performed. As shown in the drawing, the fabric material 1 formed with the glue pad 9 wraps around and between a plurality of post-stage pressure rollers 61, so that the thicknesses of the glue pad 9 and the fabric material 1 can be corrected by way of pressing.

In the bristling step, a plurality of bristle rollers 71 is disposed below the fabric material 1. The bristle rollers 71 perform the bristling operations on the fine bristles of the fabric material 1, so that the collapsed fine bristles of the fabric material 1 formed after the coating step and foaming step can be bristled and ordered.

According to the above-mentioned manufacturing steps, a semi-facture 8, which has not been cut and seamed, can be manufactured.

In addition, the fabric material 1 provided in the fabric material providing step may have a plurality of openings (not shown), wherein the colloid paste can enter the openings so that the fabric material 1 appears the pattern (not shown) arranged according to the openings. Of course, if the arrangement of the openings has been designed, the fabric material 1 of the pad of the invention can appear the predetermined pattern.

As shown in FIG. 2, the pad with the fabric material formed according to the above-mentioned manufacturing method includes the fabric material 1 and the glue pad 9. The fabric material 1 has a fabric material organization (not shown), which includes a plurality of weaving gaps (not shown). The glue pad 9 is combined with one surface of the fabric material 1 by way of foaming (the colloid paste is combined with one surface of the fabric material 1 by way of foaming according to the fabric material of the glue pad) deeply inside the weaving gaps (not shown) of the fabric material 1, and is thus completely combined with the fabric material organization (not shown). Thus, the glue pad 9 and the fabric material 1 cannot be separated from each other due to the external force or the washing of the washer, and the excellent combination strength can be obtained. As shown in the enlarged partial view of FIG. 2, the weaving gaps generated by braided wires 12 of the fabric material 1 have been combined with one portion of the glue pad 9.

Furthermore, the other surface of the fabric material 1 is further formed with a concave-convex structure 11, which is formed by weaving a plurality of thick cloth strips and a plurality of thin cloth strips alternately. The concave-convex structure 11 also enhances the friction of the used surface of the pad of the invention so that the anti-slip effect between the pad and the human body can be enhanced.

In addition, the fabric material 1 may also have a plurality of openings (not shown), and the glue pad 9 may also enter the openings during combination, so that the fabric material 1 appears the pattern (not shown) arranged according to the openings. Of course, if the arrangement of the openings has been designed, the fabric material 1 of the pad of the invention can appear the predetermined pattern.

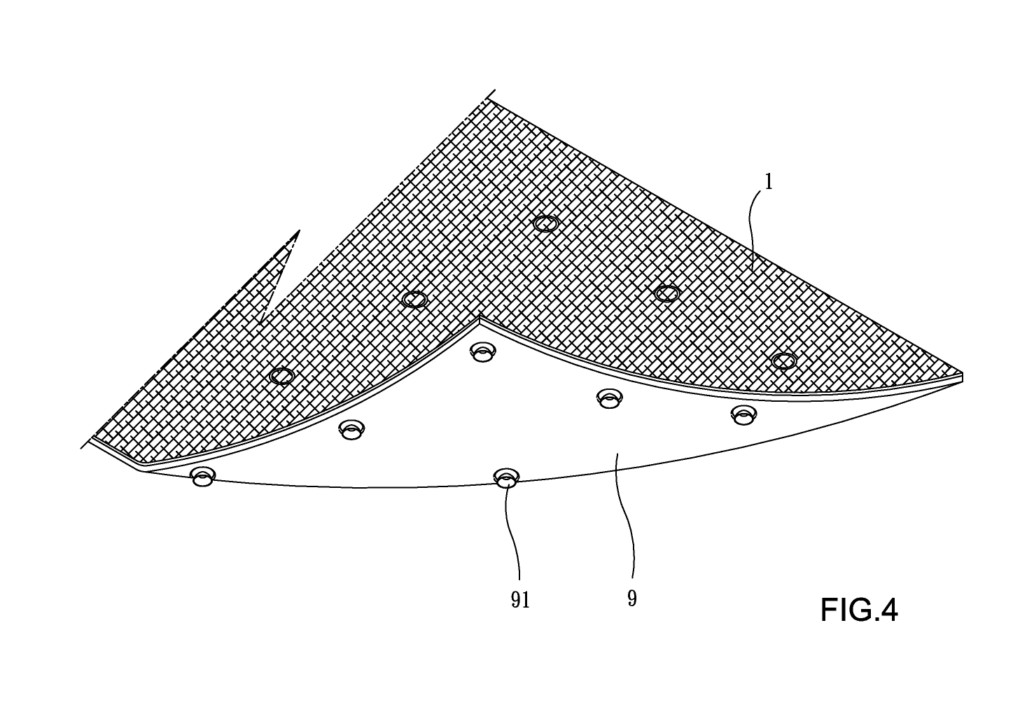

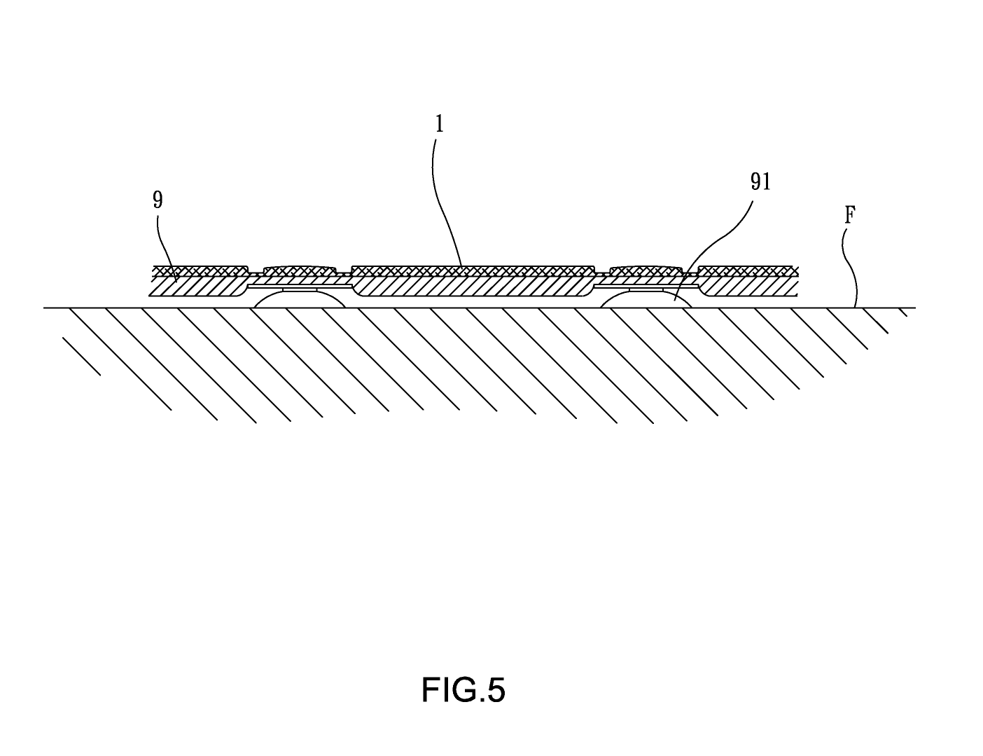

Preferably, the pad of the invention may further be applied to a step mat, an article pad, a table pad or the like. The invention is not particularly restricted thereto. Furthermore, in order to enhance the anti-slip effect, the manufacturing method of the invention may further include a sucker arranging step (not shown) after the post-stage pressing step. In the sucker arranging step, a plurality of suckers 91 is printed on the glue pad 9 by a high frequency wave. Thus, as shown in FIGS. 4 and 5, the pad with the fabric material manufactured according to the manufacturing method of the invention can have the suckers 91 formed on the glue pad 9, so that the anti-slip effect can be further enhanced, and the friction thereof can be enhanced in the more intensive exercise (e.g., dynamic Yoga) or game, while the massage effect can be obtained. As shown in FIG. 5, the presence of the sucker 91 makes the pad become slightly protrudent from the portion of the pad. When the human foot steps on the portion of the pad, the massage effect can be obtained. In addition, the pad may further be used as a bathroom floor F, and the suckers 91 can be attached to the wet bathroom floor F to achieve the real anti-slip effect.

In summary, the pad with the fabric material and the method of manufacturing the same according to the invention have the following advantages. The fabric material 1 and the glue pad 9 are directly combined together to have the elasticity of the glue pad 9, the anti-slip effect between the pad and the floor, and the sweat-absorbing effect of fabric material 1. The used surface of the pad has one layer of the fabric material 1 to have the sweat-absorbing effect, and the slipperiness and slipping can be avoided. More particularly, the fabric material 1 cannot be messed or crumpled during the exercise, and the pad can be easily cleaned after perspire in the exercise so that the bacteria growth and infection cannot be caused. Because the fabric material 1 uses the ultra-fine fiber cloth, the ultra-strong sweat-absorbing ability as well as the good soft touch and dense touch can be obtained. Because the bottom portion of the pad is the glue pad 9 formed by way of foaming and has the elasticity and anti-slip effect, the overall comfort of use can be further enhanced. Because the ultra-fine fiber cloth can be formed by weaving the bamboo charcoal yarn, the deodorization effect can be obtained. Unlike the prior art, in which the sweat is accumulated in the groove of the glue pad, the sweat can be absorbed by the used surface of the pad (i.e., the fabric material 1). So, the pad can be easily cleaned. More particularly, because the structural strength of combination between the fabric material 1 and the glue pad 9 is extremely strong and firm and the combination between the fabric material and the glue pad is the direct combination without an adhesive agent, the overall pad can be directly placed into the washer and washed therein, and the utility and convenience are significantly enhanced. Because the provided fabric material 1 may have openings (not shown), the colloid paste can enter the openings, so that the fabric material 1 can appear the pattern arranged according to the openings. Because the other surface of the fabric material 1 has the concave-convex structure 11, the used surface of the pad of the invention also has the better anti-slip effect. Because the suckers 91 are additionally formed on the glue pad 9, the pad has the real anti-slip effect and the additional massage effect.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A method of manufacturing a pad, the method comprising:
a step of providing a fabric material;
a tension averaging step of averaging tension of the fabric material by way of stretching;
a front-stage pressing step of increasing a density of the fabric material by way of pressing;
a water removing step of removing water from the fabric material by way of thermal illumination;
a coating step of applying a layer of a colloid paste onto the fabric material;
a foaming step of foaming the colloid paste by way of thermal baking;
a cooling step of cooling the colloid paste, obtained after the foaming step by way of the thermal baking, and cooling the fabric material, so that a layer of a glue pad is formed on the fabric material; and
a post-stage pressing step of pressing the glue pad and the fabric material to perform thickness correction so that a semi-facture of the pad is formed.

2. The method according to claim 1, wherein in the tension averaging step, the fabric material wraps around and between tension roller sets, each of which comprises tension rollers.

3. The method according to claim 1, wherein in the front-stage pressing step, the fabric material wraps around and between front-stage pressure rollers.

4. The method according to claim 1, wherein in the water removing step, the fabric material wraps around and between at least two heating rollers, electric heating lamp sets are disposed on opposite sides of each of the heating rollers, and each of the electric heating lamp sets comprises a plurality of electric heating lamps.

5. The method according to claim 1, wherein in the coating step, the colloid paste accommodated within a material bucket is sprayed onto the fabric material, and a supporting element is disposed below the fabric material and opposite the material bucket to support the fabric material.

6. The method according to claim 1, further comprising, after the coating step, a smoothening step of smoothening the colloid paste applied in the coating step.

7. The method according to claim 6, wherein in the smoothening step, a plurality of scrapers is disposed above the fabric material applied with the colloid paste, the scrapers smoothen the colloid paste on the translating fabric material, and a supporting element is disposed below the fabric material and corresponding to the scrapers to support the fabric material.

8. The method according to claim 7, wherein each of the scrapers has scratches for scratching the glue pad with textures.

9. The method according to claim 5, wherein the supporting element is in the form of a substrate or a plurality of small rollers arranged in parallel.

10. The method according to claim 7, wherein the supporting element is in the form of a substrate or a plurality of rollers arranged in parallel.

11. The method according to claim 1, wherein in the foaming step, the fabric material applied with the colloid paste passes through and between two opposite ovens, so that the colloid paste is foamed.

12. The method according to claim 1, wherein in the cooling step, the fabric material with the formed colloid paste passes through and between two opposite cooling devices so that the layer of the glue pad is formed on the fabric material.

13. The method according to claim 1, wherein in the post-stage pressing step, the fabric material with the formed glue pad wraps around and between a plurality of post-stage pressure rollers to correct thicknesses of the glue pad and the fabric material.

14. The method according to claim 1, further comprising, after the post-stage pressing step, a bristling step of disposing a plurality of bristle rollers below the fabric material, wherein the bristle rollers perform bristling operations on fine bristles of the fabric material.

15. The method according to claim 1, wherein the fabric material provided in the step of providing the fabric material has a plurality of openings, and the colloid paste enters the openings so that the fabric material appears a pattern arranged according to the openings.

16. The method according to claim 1, wherein the fabric material provided in the step of providing the fabric material is one of an ultra-fine fiber cloth and a towel cloth.

17. The method according to claim 16, wherein one of the ultra-fine fiber cloth and the towel cloth is formed by weaving one of a bamboo charcoal yarn and a PETE bottle recycled yarn.

18. The method according to claim 1, further comprising, after the post-stage pressing step, a sucker arranging step of printing a plurality of suckers on the glue pad by a high frequency wave.

19. A pad manufactured according to the method of claim 1, the pad comprising:
the fabric material having a fabric material organization, which comprises a plurality of weaving gaps; and
the glue pad combined with one surface of the fabric material by way of foaming, wherein the glue pad is combined with the fabric material deeply inside the weaving gaps of the fabric material and is thus completely combined with the fabric material organization.

20. The pad according to claim 19, wherein the other surface of the fabric material has a concave-convex structure.

21. The pad according to claim 19, wherein the fabric material is one of an ultra-fine fiber cloth and a towel cloth.

22. The pad according to claim 21, wherein one of the ultra-fine fiber cloth and the towel cloth is made by weaving one of a bamboo charcoal yarn and a PETE bottle recycled yarn.

23. The pad according to claim 19, further comprising a plurality of suckers disposed on the glue pad.
